(19) United States
(12) Patent Application Publication
(10) Pub. No.: US 2015/0377408 A1
(43) Pub. Date: Dec. 31, 2015

(54) SPIGOT INSULATOR AND METHOD FOR MAKING A SPIGOT INSULATOR

(71) Applicant: Tammy Johnson, Waco, TX (US)

(72) Inventor: Tammy Johnson, Waco, TX (US)

(21) Appl. No.: 14/316,829

(22) Filed: Jun. 27, 2014

(51) Int. Cl. F16L 59/16; B32B 38/00; B32B 37/16

(52) U.S. Cl. CPC F16L 59/161; B32B 37/16; B32B 38/0004; B32B 38/0012; B32B 2305/022; B32B 2307/304; B32B 2597/00

(57) ABSTRACT

An insulating device, and method for fabricating an insulating device from a segment of tubular foam insulation, primarily for use in protecting exterior water spigots against sub-freezing temperatures and the resulting risk of plumbing system and property damage arising from “frozen pipes”.

### BACKGROUND OF THE INVENTION

1. Field of the Invention

The present invention relates to devices and method for insulating spigots that are, or may be exposed to sub-freezing temperatures.

2. Background Information

One law of nature dictates water expands when it freezes. One of the more damaging impacts of this law of nature arises when water in plumbing pipes freezes. This most often occurs (at least in the case of occupied building and dwellings) when outdoor spigots are exposed to sub-freezing temperatures.

The consequences of “frozen pipes” can be devastating, and include, not only costly plumbing repairs, but the often, far more costly property damage that attends the flooding of the residence or building when such pipes burst under the pressure of the expanding ice.

Frequently-employed measures for preventing “frozen pipes” include: (1) opening spigots to allow a continuous flow of water during times of sub-freezing temperatures; and (2) using commercially-available insulation shrouds. Other, often less practical solutions include: (1) turning off water supplies to a dwelling or other affected building; and (2) applying heat-producing, electrical resistance wire(s) to exposed spigots.

Each and every of the currently known options for preventing “frozen pipes” has its shortfalls. Allowing water to flow continuously not only wastes an increasingly limited resource (especially in more arid regions), but may produce hazardous, frozen puddles near each spigot, especially if the flow extends onto walkways, stairs or the like. Furthermore, experience teaches that spigots often self-close, when a user allows too small a stream to flow.

Commercially available insulation shrouds for spigots are difficult to attach and (at least in light of the invention hereafter described) are relatively, needlessly expensive. Attaching the currently available insulation shrouds involves “fishing” with an attachment device for a portion of the spigot to attach the shroud—a frequently frustrating task when (as is often the case) the shroud is being applied “at the last moment”, during uncomfortably cold weather. An example of such a product is available from the FROST KING company of Mahwah, N.J., U.S., and is designated as the “Frost King Standard Styrofoam Faucet Cover”.

Turning off water supplies is clearly not a viable option for an occupied building (though it is the only viable option for any unheated building, as the effectiveness of insulating spigot depends upon heat within the building to reach and be entrained about the otherwise exposed spigots).

Electrical resistance heat wire applications are both potentially expensive and dangerous—the latter because of electricity's proximity to water and metal fixtures.

### SUMMARY OF THE INVENTION

In view of the foregoing, it would well serve all who reside in, or otherwise occupy buildings that are exposed to sub-freezing temperatures and that have exterior spigots to provide a cost-effective, effective, and easily applied device for combating the effects of sub-freezing temperatures on such exterior spigots and the conduits to which they are attached.

Accordingly, embodiments and practice of the present invention provide an extremely cost-effective, effective, and easily applied solution to the “frozen pipe” problem for an occupied dwelling or other building.

The present invention is of both a method for forming a spigot insulation device, and of the end product of such formation. The invented method involves, and the end product comprises a length of commonly-available, tubular foam insulation, such as is sold for insulating lengths of coolant conduits in air conditioning systems. Most often, such insulation material is pre-cut with a lengthwise cut along the length of the tube, and includes pre-applied adhesive to the opposing cut faces (often with a cover-strip to prevent pre-mature adherence to anything but the opposing face, after installation). An example of such insulating, foam tubing is sold also by the FROST KING company of Mahwah, N.J., U.S.

The insulation device, and the end product of the present method for making the device includes a length of the tubular insulation that is folded along a mid-point such that a first length of each cut face is juxtaposed and adhered to a second length of each cut face to form a pouch-like structure into which a spigot is inserted when “winterizing” the spigot. The length of the device is such that it can envelope the spigot at the end of the device that defines the opening, and can abut the surface from which the spigot extends.

Attractive aspects of the device of the present invention include: (1) minimal cost of production; (2) effectiveness; and (3) extreme ease of installation and removal.

### BRIEF DESCRIPTION OF THE DRAWINGS

FIG. 1 is a perspective view of a length of tubular, foam insulation as is used in connection with the present invention.

FIG. 2 is a perspective view of an insulating device of the present invention.

### DETAILED DESCRIPTION OF THE PREFERRED EMBODIMENT

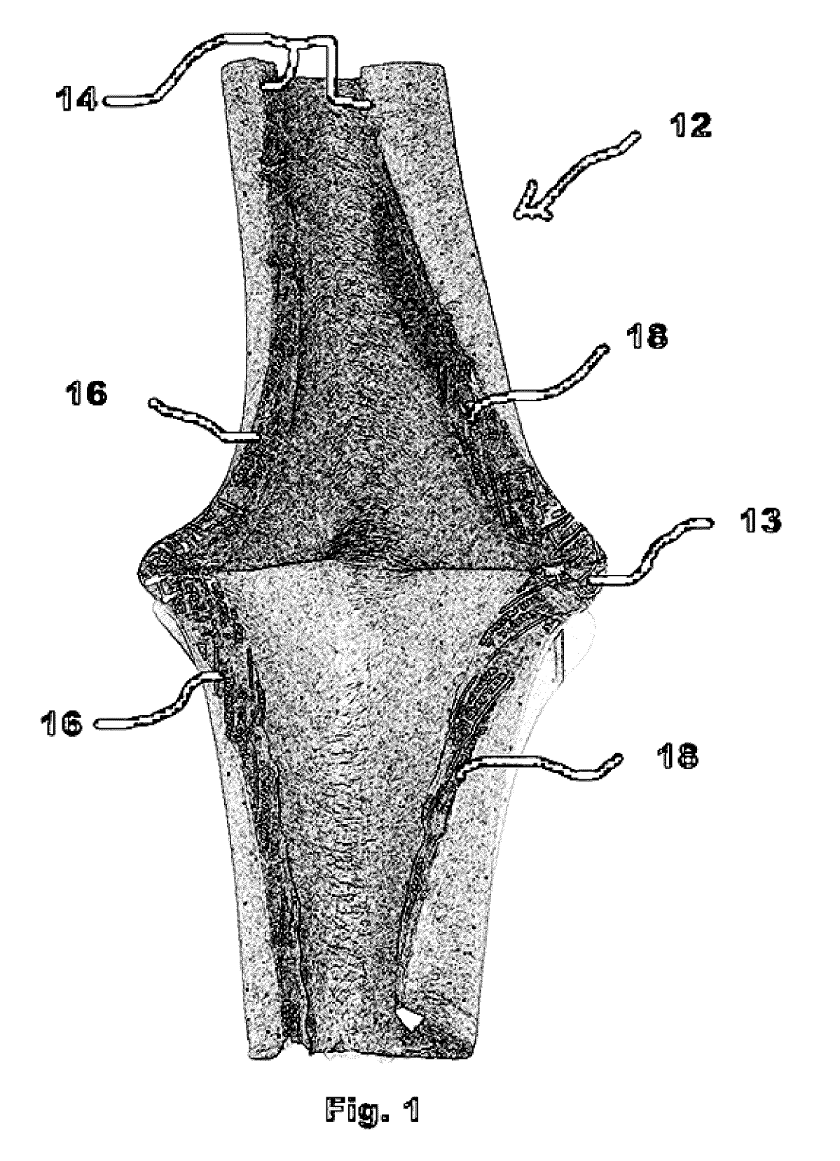

Referring to FIG. 1, the insulation device of the present invention (later identified by reference number 10) is formed of a unit 12 of tubular foam insulation. Unit 12 includes (or is made to include) an elongate cut 14 whereby formed is a first cut face 16 and a second cut face 18. Though not visible in the drawings, adhesive is often present on one or both cut faces 16 and 18, having been applied by the manufacturer, and often involves a protective strip (not shown) that exposes the adhesive only when a desired positioning of the tubular insulation is complete.

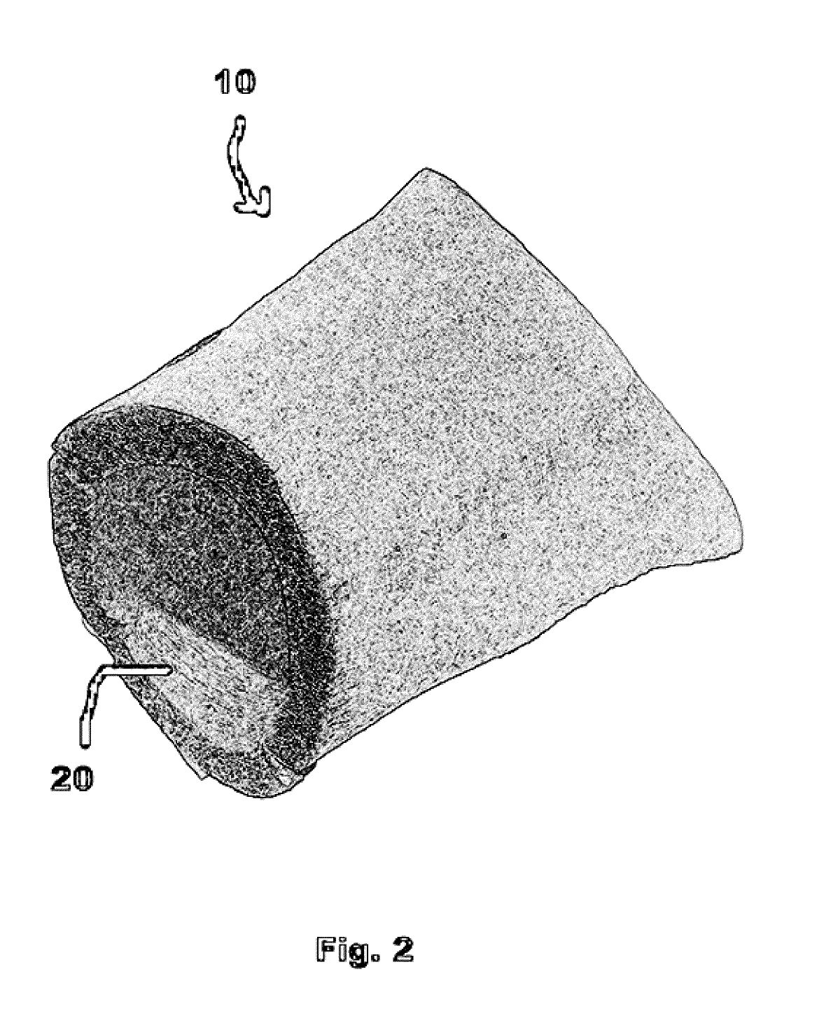

The typical use of the tubular insulation involves positioning a to-be-protected length of conduit within the cylindrical cavity (defined within a length of tubular foam insulation), by passing the conduit through the elongate cut, after which the opposing cut faces are adhered, one to the other, and the conduit is secured within a corresponding length of tubular insulation. Referring to FIG. 2, the present insulating device 10 involves, however, bending the unit 12 substantially at a mid-point 13 and juxtaposing an approximately first half of the first cut face 16 against the remaining second half of the first cut face 16, and, in like manner, juxtaposing an approximately first half of the second cut face 18 against the remaining second half of the second cut face 18. Once these respective lengths of cut faces are adhered, a pouch-like structure is formed (as depicted), with an opening 20 at one end of device 10 that allows insertion of a spigot into the cavity 22 formed by the described structure.

It should be noted that the elongate cut 14 may comprise multiple lengths (such as when a mid-point of the cut is left uncut), or may be a single cut that runs the entire length of the unit 12. Also, though the adhesive most often is pre-applied by the manufacturer of the tubular insulation, it may be applied by one who fabricates the device 10.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A method for making a spigot insulator comprising the steps of:
selecting a unit of insulation material of a substantially cylindrical configuration, said unit having an elongate cut extending substantially axially of said unit to form a first cut face and an opposing second cut face;
bending said unit at substantially a mid-point whereby a first portion of said first cut face, extending along a first axial length of said unit contacts a second length of said first cut face that extends along a second length of said unit and whereby a first portion of said second cut face, extending along said second axial length of said unit contacts a second length of said second cut face that extends along said second length of said unit;
adhering said first portion of said first cut face to said second portion of said first cut face; and
adhering said first portion of said second cut face to said second portion of said second cut face.

2. The method of claim 1 wherein said elongate cut comprises a plurality of cut lengths with intervening, uncut lengths of said insulation material between adjacent cut lengths.

3. The method of claim 1 wherein said unit further comprises adhesive means applied to one or more of said first and second cut faces.

4. The method of claim 1 further comprising the step of forming said elongate cut.

5. The method of claim 4 further comprising the step of applying adhesive means to one or more of said first and second cut faces.

6. A spigot insulator comprising:
a unit of insulation material formed of a length of foam insulation material of a substantially cylindrical configuration, said unit having an elongate cut extending substantially axially of said unit to form a first cut face and an opposing second cut face;
said unit having been bent at substantially a mid-point whereby a first portion of said first cut face, extending along a first axial length of said unit contacts and is adhered to a second length of said first cut face that extends along a second length of said unit and whereby a first portion of said second cut face, extending along said second axial length of said unit contacts and is adhered to a second length of said second cut face that extends along said second length of said unit;
said first portion of said first cut face being adhered t said second portion of said first cut face;
said first portion of said second cut face being adhered to said second portion of said second cut face;
said insulator defining at a first insulator end an orifice that opens into an elongate enclosure defined by said insulation material with a closed second end of said insulator being formed by said insulation material at the point of the bending of said unit at said midpoint.

7. The insulator of claim 6 wherein said elongate cut comprises a plurality of cut lengths with intervening, uncut lengths of said insulation material between adjacent cut lengths.
